(19) United States
(12) Patent Application Publication
(10) Pub. No.: US 2026/0177039 A1
(43) Pub. Date: Jun. 25, 2026

(54) Electric Power Generating System and Method of Use

(71) Applicant: Philip Henry, Cortland, NY (US)

(72) Inventor: Philip Henry, Cortland, NY (US)

(21) Appl. No.: 19/260,698

(22) Filed: Jul. 7, 2025

Related U.S. Application Data
(60) Provisional application No. 63/735,938, filed on Dec. 19, 2024.

(51) Int. Cl. F03G 3/08; H02K 7/10

(52) U.S. Cl. CPC F03G 3/083; H02K 7/1004

(57) ABSTRACT

An electric power generating system that extracts mechanical energy from the Earth's rotation is disclosed. The system includes a pair of parallel beam members rotatably mounted on pivot points supported by ground-fixed columns. At the ends of the beam members, gyroscopes are mounted within gimbals, each configured with an axis of rotation perpendicular to the Earth's axis of rotation. As the Earth rotates, the gyroscopes resist reorientation, inducing torque on the gimbals and initiating precession. This precessional motion causes the gimbals to rotate, which is transmitted via pulleys and belts to a central shaft. The belt-driven mechanism connects each gimbal pulley to the double central pulley in a figure-8 configuration which generates an opposite rotation in the beam members, maintaining system balance and sustaining continuous motion. This motion is converted into electrical energy by a generator operatively coupled to the central shaft.

### CROSS-REFERENCE TO RELATED APPLICATION

The present application claims priority to, and the benefit of, U.S. Provisional Application No. 63/735,938, which was filed on Dec. 19, 2024, and is incorporated herein by reference in its entirety.

### FIELD OF THE INVENTION

The present invention generally relates to the field of renewable energy systems. More specifically, the present invention relates to a clean electric power generating system. The system comprises a pair of parallel, rotatable beam members mounted on fixed support columns, with each beam end supporting a gyroscope housed within a gimbal. The gimbals are operatively connected via pulleys and belts to a central shaft, enabling counter-rotational movement as a result of torque induced by Earth's rotation. In one embodiment, the system includes a double central pulley mechanically linked to an electric generator, enabling for the conversion of continuous rotational motion into electric power. Accordingly, the present disclosure makes specific reference thereto. Nonetheless, it is to be appreciated that aspects of the present invention are also equally applicable to other like applications, devices, and methods of manufacture.

### BACKGROUND

By way of background, electrical energy is required for modern industrial, commercial, and residential use. Conventional methods of generating electric power primarily rely on fossil fuels, nuclear fission, wind turbines, and hydroelectric systems. While traditional sources are effective in producing energy, such traditional sources present various drawbacks.

Fossil fuel-based energy production emits greenhouse gases and pollutants that contribute to environmental degradation and climate change. Additionally, the geopolitical implications of fossil fuel dependency can lead to energy insecurity, especially when fuel sources are located in politically unstable or unfriendly regions. Alternative energy sources such as wind, hydroelectric, and nuclear power also face limitations. Wind turbines and hydroelectric power stations require large geographic footprints and favorable environmental conditions, which may not be available or sustainable in all regions. Nuclear energy, while efficient, carries safety concerns, regulatory burdens, and long-term waste management challenges. Accordingly, individuals desire a clean, continuous, and geographically independent method for generating electrical energy without relying on environmentally harmful or politically constrained resources.

Therefore, there exists a long-felt need in the art for a clean, sustainable, and location-independent energy generation system. There is a long-felt need for a power generation system that does not rely on fossil fuels, solar radiation, wind, or hydroelectric infrastructure. Additionally, there is a long-felt need for a system that eliminates the space, maintenance, and site limitations associated with conventional wind and solar installations. Furthermore, there is a long-felt need for a mechanism that can provide continuous mechanical energy in any geographic location, independent of weather or daylight.

The subject matter disclosed and claimed herein, in one embodiment, comprises a clean electric power generating system that utilizes the interaction between Earth's rotation and the inertial stability of gyroscopes. The system includes a pair of parallel beam members rotatably mounted on vertically fixed support columns. The beam pair has a gyroscope mounted at either end within a tiltable gimbal, and each gimbal is operatively connected to pulleys and belts. As the Earth rotates, the gyroscopes resist spatial reorientation, causing torque on the gimbals and initiating precessional rotation. This rotation is transferred through the pulley and belt system to create a counter-rotation of the beam structure, which in turn drives a generator shaft to produce electricity. Precession can be described as the slow movement of the axis of a spinning body around another axis due to a torque (such as gravitational influence) acting to change the direction of the first axis. It can be demonstrated by watching the circle slowly traced out by the pole of a spinning gyroscope.

In another embodiment, the clean electric power generating system includes a double central pulley mounted between the pair of rotating beams. This central pulley is operatively connected to each gimbal pulley via belts, forming a mechanically coupled system that balances rotational motion. The belt from each gimbal pulley to the double central pulley is crossed in a figure-8 configuration so that, when the gimbal rotates in one direction, the central pulley rotates in the other direction. The gimbal rotation, driven by gyroscopic precession, turns the central pulley in a regulated manner.

In this manner, the clean electric power generating system of the present invention fulfills the long-felt need for a scalable, maintenance-minimal, and eco-friendly energy solution. The system overcomes the limitations of wind, solar, and fossil fuel systems by extracting energy directly from the Earth's rotational motion. The system may be adapted for a range of settings, including off-grid applications, industrial power generation, or backup systems in disaster-prone areas. The system also reduces dependency on traditional infrastructure, offers a smaller environmental footprint, and introduces a novel use of gyroscopic physics to achieve sustainable electrical power generation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a clean electric power generating system. The system includes a pair of rigid beam members positioned substantially parallel to one another, a pair of support columns, each support column is fixed to a ground surface and supports a corresponding beam member at approximately a midpoint thereof via a pivot point that enables rotational movement of each beam about its midpoint, a pair of gimbals, each gimbal is mounted at opposing ends of the pair of beam members, a pair of gyroscopes, each gyroscope is operatively coupled to a corresponding gimbal, each gyroscope has an axis of rotation oriented perpendicular to the axis of rotation of the Earth, a plurality of pulleys, at least one or more pulleys are operatively connected to a corresponding gimbal and a double central pulley is positioned between the pair of beam members, a plurality of belts are operatively connecting the pulleys such that rotation of the gimbals causes counter-rotation of the double pulley via belt motion and pulley engagement, and wherein the counter-rotation of the double pulley induces rotation of the beam members about their respective pivot points to generate mechanical energy which is converted into electrical energy.

In another aspect, a system for converting Earth's rotational energy into electrical energy is disclosed. The system comprises a frame fixed to the Earth and rotatable with Earth's rotation, at least one pair of spinning gyroscopes mounted on rotatable gimbals, each gyroscope has an axis of rotation maintained perpendicular to Earth's axis, a plurality of pulleys and belts configured to transfer gimbal rotation to a central shaft, wherein the gyroscopes maintain inertial orientation, causing torque on the gimbals due to Earth's rotation, thereby initiating precession, wherein the torque-induced precession causes the gimbals to rotate, transmitting motion through the belts and pulleys to rotate the central shaft, and an electric generator is mechanically coupled to the central shaft, configured to convert the rotational mechanical motion into electric power.

In another embodiment, an apparatus for harvesting mechanical energy from gyroscopic precession induced by Earth's rotation is disclosed and comprises a support structure fixed to the ground, a pair of beam members mounted rotatably on the support structure, a pair of gyroscopes, each mounted on a respective gimbal affixed to an end of the beam members, the gyroscopes configured to spin on an axis perpendicular to Earth's rotational axis, wherein rotation of the Earth imparts a torque on the gyroscopes, causing the gimbals to precess, and wherein the precession of the gimbals induces rotation of the beam members about their pivot points, enabling mechanical energy harvesting.

In one embodiment, a counter-rotational mechanical transmission system for use in a gyroscopic energy harvester is disclosed. The system includes a first pulley mounted on a first gimbal axis at one end of a beam, a second pulley mounted on a second gimbal axis at the opposite end of the beam, a double central pulley mounted on a central axis between the first and second pulleys, a first belt connects the first pulley to one side of the central pulley, a second belt connects the second pulley to the other side of the central pulley. The belt from each gimbal pulley to its central pulley is crossed in a figure-8 configuration so that, when the gimbal rotates in one direction, the central pulley rotates in the other direction. Thus, when the gimbals are rotating in one direction, the central pulley and the beam to which it is connected rotate in the opposite direction. The shaft of the beam is connected to an electric generator, which rotates, thereby creating electricity.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of clean electric power generating system of the present invention in accordance with the disclosed structure;

FIG. 2 illustrates a perspective view showing the position of pulleys in the clean electric power generating system of the present invention in accordance with the disclosed structure;

FIG. 3 illustrates a flow chart depicting a process of generation of electricity using the clean electric power generating system of the present invention in accordance with the disclosed structure; and

FIG. 4 illustrates a perspective view showing position of the pair of beams during production of electricity using the electricity generation system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a clean, sustainable, and location-independent energy generation system. There is a long-felt need for a power generation system that does not rely on fossil fuels, solar radiation, wind, or hydroelectric infrastructure. Additionally, there is a long-felt need for a system that eliminates the space, maintenance, and site limitations associated with conventional wind and solar installations. Furthermore, there is a long-felt need for a mechanism that can provide continuous mechanical energy in any geographic location, independent of weather or daylight.

The present invention, in one exemplary embodiment, is a counter-rotational mechanical transmission system for use in a gyroscopic energy harvester. The system includes a first pulley mounted on a first gimbal axis at one end of a beam, a second pulley mounted on a second gimbal axis at the opposite end of the beam, a double central pulley mounted on a central axis between the first and second pulleys, a first belt connects the first pulley to one side of the central pulley, a second belt connects the second pulley to the other side of the central pulley. The belt from each gimbal pulley to its central pulley is crossed in a figure-8 configuration so that, when the gimbals are rotating in one direction, the central pulley and the beam to which it is connected rotate in the opposite direction. The shaft of the beam is connected to an electric generator, which rotates, creating electricity.

Reference will now be made in detail to the present preferred embodiments of the invention, examples of which are illustrated in the accompanying drawings. Wherever possible, the same reference numerals are used in the drawings and the description to refer to the same or like parts.

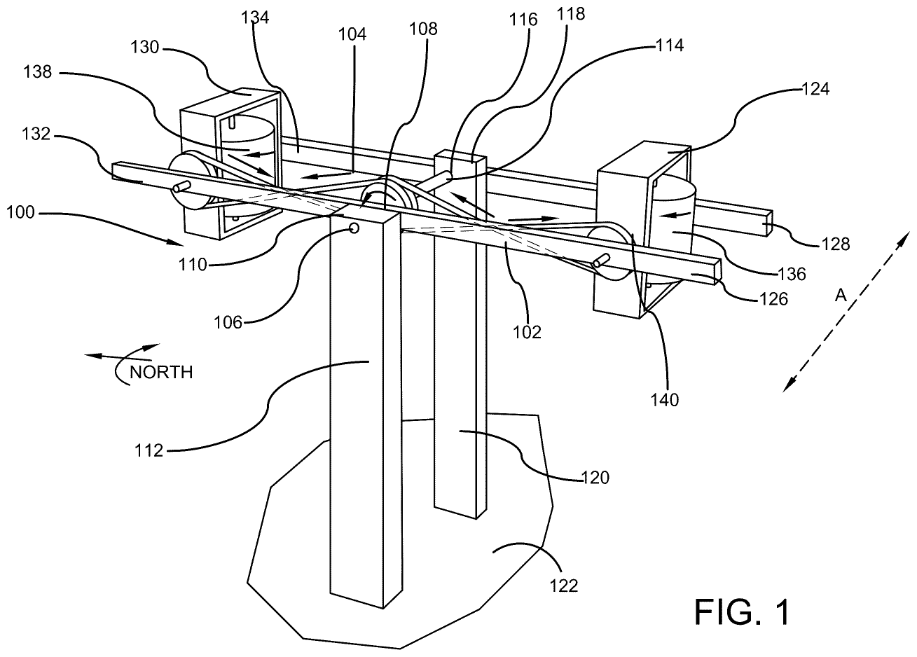

Referring initially to the drawings, FIG. 1 illustrates a perspective view of clean electric power generating system of the present invention in accordance with the disclosed structure. The clean electric power generating system 100 of the present invention is designed to extract mechanical energy from the Earth's rotation, using the gyroscopic effect and the conservation of angular momentum to generate clean electric power. More specifically, the clean electric power generating system 100 includes a pair of parallel sturdy and durable beam members 102, 104. A first beam 102 of the pair of beam members 102, 104 is mounted on a first pivot point 106 at about the midpoint 108 of the first beam 102. The pivot point 106 is disposed at the top end 110 of the first support column 112 which is secured to a surface or ground 122. The second beam 104 of the pair of beam members 102, 104 is substantially parallel to the first beam 102 and is mounted on a second pivot point 114 at about midpoint 116 of the second beam 104. The second pivot point 114 is disposed at the top end 118 of the second support column 120 which is also secured to the surface or ground 122. The support columns 112, 120 are parallel and are fixed to the ground 122. The rigid beams 102, 104 are configured to rotate along the respective pivot points 106, 114.

A first gimbal 124 is mounted at the first ends 126, 128 of the beams 102, 104 respectively. A second gimbal 130 which is identical to the first gimbal 124, is mounted at the respective second ends 132, 134 of the beams 102, 104. A first gyroscope 136 is operatively coupled to the first gimbal 124, and a second gyroscope 138 is operatively coupled to the second gimbal 130. Each gyroscope has its own axis of rotation (shown by arrow “A”), and the axis of rotation is perpendicular to Earth's axis of rotation. The gimbals 124, 130 are designed to tilt the respective gyroscopes 136, 138 for maintaining the rotational direction of the gyroscopes.

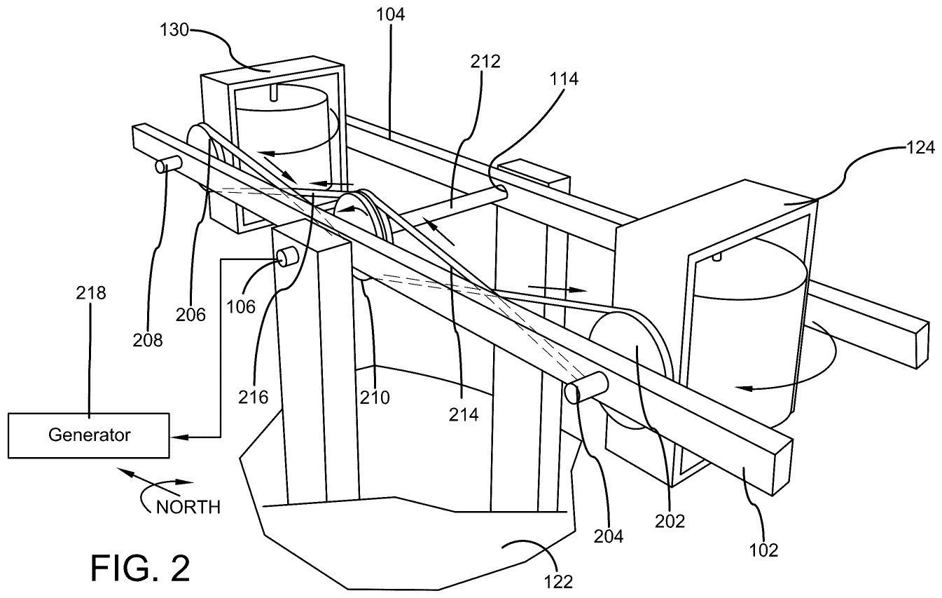

The system 100 includes a pulley system 140 and belts passing through the pulley system 140. The pulleys are attached to the axis of gimbals 124, 130 as illustrated and described in FIG. 2. As illustrated in FIG. 1, the beams 102, 104 are horizontally aligned when the gyroscopes 136, 138 are at rest and are not rotating. Specifically, the gyroscopes 136, 138 resist changes in orientation, so as the Earth turns, the rotation of the Earth applies a torque to the gyroscopes 136, 138 due to the mismatch between Earth's rotation and the gyroscopic inertia.

FIG. 2 illustrates a perspective view showing the position of pulleys in the clean electric power generating system of the present invention in accordance with the disclosed structure. As illustrated, the first pulley 202 of the pulley system 140 is operatively coupled to axis 204 of the first gimbal 124, a second pulley 206 is operatively coupled to the axis 208 of the second gimbal 130 and a double central pulley 210 is operatively coupled to a central shaft 212 disposed across the pivot points 106, 114.

The double central pulley 210 is rotatably coupled to the first pulley 202 using a first belt 214 in a figure-8 configuration. The double central pulley 210 is also rotatably coupled to the second pulley 206 using a second belt 216 in a figure-8 configuration. The belts 214, 216 are used for coupling motion of the gimbals and double central pulley 210 for transferring rotational motion. Since each belt is connected from its gimbal pulley to the double central pulley 210 in a figure-8 configuration, when either gimbal rotates in one direction, the corresponding belt causes the double central pulley 210 to rotate in the opposite direction, and as both the gimbals 124, 130 rotate, the pulleys 202, 206, 210 drive the belts 214, 216. The movement of the belts 214, 216 transfer that motion to rotate the beam pair 102, 104 to generate electricity. The double central pulley 210 rotates the central shaft 212 which is coupled to an electric generator 218 wherein the rotational motion of the beams 102, 104 is transferred to the generator 218 for electricity generation.

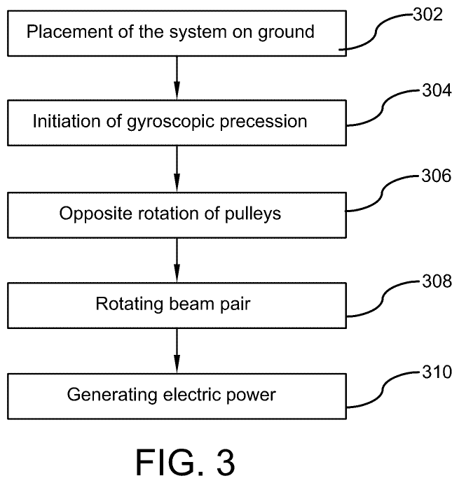

FIG. 3 illustrates a flow chart depicting a process of generation of electricity using the clean electric power generating system of the present invention in accordance with the disclosed structure. Initially, system 100 is placed on the ground, and as the Earth rotates, the support columns 112, 120 rotate and the gyroscopes 136, 138 maintain their spatial orientation due to conservation of angular momentum (Step 302). The relative motion between the rotating Earth and the gyroscopes 136, 138 causes a torque on the gimbals which initiates gyroscopic precession (Step 304). Then, as gyroscopic precession forces the gimbals to rotate, the attached pulleys also rotate and the belts 214, 216 cause the equal and opposite rotation of the double central pulley 210 (Step 306). This introduces a reactive torque on the beam pair causing it to rotate in the direction opposite to the gimbal rotation (Step 308).

The combined interaction of Earth's rotation, gyroscopic stability, and mechanical coupling produces a continuous and cyclic rotational motion of the beam and gimbal system. The electric generator or dynamo receives the rotational motion, and the rotational motion is converted into electric power by the generator rotational motion via conventional electromagnetic induction methods (Step 310).

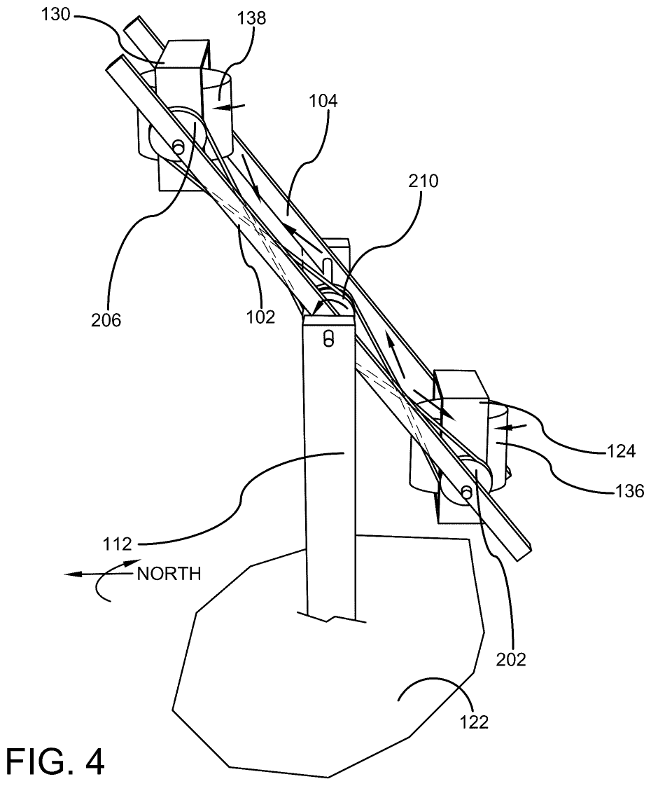

FIG. 4 illustrates a perspective view showing position of the pair of beams during production of electricity using the electricity generation system of the present invention in accordance with the disclosed structure. As the Earth rotates and gyroscopes 136, 138 remain static or resist reorientation, the gimbals 124, 130 rotate due to the torque created by Earth's rotation. The pulleys 202, 206 attached to the gimbals 124, 130 cause the torque generated by the gimbal precession to transfer to the beam pair 102, 104 and rotate the gimbals 124, 130 in the opposite direction to tilt the beams 102, 104 and to produce electricity.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “clean electric power generating system”, “electricity generation system”, “counter-rotational mechanical transmission system”, and “system” are interchangeable and refer to the clean electric power generating system 100 of the present invention.

Notwithstanding the foregoing, the clean electric power generating system 100 of the present invention can be of any suitable configuration as is known in the art without affecting the overall concept of the invention, provided that it accomplishes the above-stated objectives. One of ordinary skill in the art will appreciate that the clean electric power generating system 100 as shown in the FIGS. are for illustrative purposes only, and that many other configurations of the clean electric power generating system 100 are well within the scope of the present disclosure. Although the dimensions of the clean electric power generating system 100 are important design parameters for user convenience, the clean electric power generating system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric power generating system for extracting mechanical energy from Earth's rotation, the electric power generating system comprising:
a first support column, a second support column, a first beam member, a second beam member, a first pivot point, a second pivot point, a first gimbal, a second gimbal, a first gyroscope, and a second gyroscope;
wherein said first beam member is parallel with said second beam member;
wherein said first beam is mounted on said first pivot point at a midpoint of said first beam;
wherein said first pivot point proximal to a top end of said first support column;
wherein said first support column secured to the ground;
wherein said second beam is mounted on said second pivot point at a midpoint of said second beam;
wherein said second pivot point proximal to a top end of said second support column;
wherein said second support column secured to the ground;
wherein said first support column is parallel to said second support column;
wherein said first beam rotatable about said first pivot point;
wherein said second beam rotatable about said second pivot point;
wherein said first gimbal mounted between a first end of said first beam and a first end of said second beam;
wherein said second gimbal mounted between a second end of said first beam and a second end of said second beam;
wherein said first gyroscope operatively coupled to said first gimbal;
wherein said second gyroscope operatively coupled to said second gimbal;
wherein said first gyroscope having a first axis of rotation;
wherein said second gyroscope having a second axis of rotation;
wherein said first axis of rotation and said second axis of rotation perpendicular to the Earth's axis of rotation;
wherein said first gimbal tilts said first gyroscope for maintaining a first rotational direction of said first gyroscope;
wherein said second gimbal tilts said second gyroscope for maintaining a second rotational direction of said second gyroscope;
wherein said first gyroscope and said second gyroscope resist changes in orientation; and
further wherein the rotation of the Earth applies a torque to said first gyroscope and said second gyroscope.

2. The electric power generating system for extracting mechanical energy from Earth's rotation of claim 1 further comprising a pulley system having belts passing through said pulley system and connecting a first pulley and a second pulley to a central double pulley.

3. The electric power generating system for extracting mechanical energy from Earth's rotation of claim 2, wherein said first pulley operatively coupled to an axis of said first gimbal.

4. The electric power generating system for extracting mechanical energy from Earth's rotation of claim 3, wherein said second pulley operatively coupled to an axis of said second gimbal.

5. The electric power generating system for extracting mechanical energy from Earth's rotation of claim 4, wherein said pulley system having said double central pulley between said first pulley and said second pulley.

6. The electric power generating system for extracting mechanical energy from Earth's rotation of claim 5, wherein said first beam horizontally aligned with said second beam.

7. The electric power generating system for extracting mechanical energy from Earth's rotation of claim 6, wherein said double central pulley operatively coupled to a central shaft disposed across said first pivot point and said second pivot point.

8. The electric power generating system for extracting mechanical energy from Earth's rotation of claim 7, wherein said double central pulley rotatably coupled to said first pulley with a first belt and rotatably coupled to said second pulley with a second belt.

9. The electric power generating system for extracting mechanical energy from Earth's rotation of claim 8, wherein said first belt and said second belt transfer rotational motion from said first gimbal and said second gimbal to said first beam and said second beam for generating electricity.

10. The electric power generating system for extracting mechanical energy from Earth's rotation of claim 9, wherein said first gimbal rotates in one direction and said second gimbal rotates in the same direction, and said double central pulley rotates in an opposite direction.

11. The electric power generating system for extracting mechanical energy from Earth's rotation of claim 10, wherein the rotational motion of said first beam and said second beam rotates said central shaft, and further wherein said central shaft coupled to an electric generator for the generating of electricity.

12. An electric power generating system for extracting mechanical energy from Earth's rotation, the electric power generating system comprising:
a first support column, a second support column, a first beam member, a second beam member, a first pivot point, a second pivot point, a first gimbal, a second gimbal, a first gyroscope, a second gyroscope, and a pulley system;
wherein said first beam member is parallel with said second beam member;
wherein said first beam is mounted on said first pivot point at a midpoint of said first beam;
wherein said first pivot point proximal to a top end of said first support column;
wherein said first support column secured to the ground;
wherein said second beam is mounted on said second pivot point at a midpoint of said second beam;
wherein said second pivot point proximal to a top end of said second support column;
wherein said second support column secured to the ground;
wherein said first support column is parallel to said second support column;
wherein said first beam rotatable about said first pivot point;
wherein said second beam rotatable about said second pivot point;
wherein said first gimbal mounted between a first end of said first beam and a first end of said second beam;
wherein said second gimbal mounted between a second end of said first beam and a second end of said second beam;
wherein said first gyroscope operatively coupled to said first gimbal;
wherein said second gyroscope operatively coupled to said second gimbal;
wherein said first gyroscope having a first axis of rotation;
wherein said second gyroscope having a second axis of rotation;
wherein said first axis of rotation and said second axis of rotation perpendicular to the Earth's axis of rotation;
wherein said first gimbal tilts said first gyroscope for maintaining a first rotational direction of said first gyroscope;
wherein said second gimbal tilts said second gyroscope for maintaining a second rotational direction of said second gyroscope;
wherein said first gyroscope and said second gyroscope resist changes in orientation;
wherein the rotation of the Earth applies a torque to said first gyroscope and said second gyroscope;
wherein said pulley system having belts passing through said pulley system and connecting a first pulley and a second pulley to a double central pulley;
wherein said pulley system having said double central pulley between said first pulley and said second pulley;
wherein said double central pulley operatively coupled to a central shaft disposed across said first pivot point and said second pivot point; and
further wherein said double central pulley rotatably coupled to said first pulley with a first belt and rotatably coupled to said second pulley with a second belt.

13. The electric power generating system for extracting mechanical energy from Earth's rotation of claim 12, wherein said first pulley operatively coupled to an axis of said first gimbal.

14. The electric power generating system for extracting mechanical energy from Earth's rotation of claim 13, wherein said second pulley operatively coupled to an axis of said second gimbal.

15. The electric power generating system for extracting mechanical energy from Earth's rotation of claim 14, wherein said first beam horizontally aligned with said second beam when said first gyroscope and said second gyroscope are at rest.

16. The electric power generating system for extracting mechanical energy from Earth's rotation of claim 15, wherein said first belt and said second belt transfer rotational motion from said first gimbal and said second gimbal to said first beam and said second beam through said double central pulley.

17. The electric power generating system for extracting mechanical energy from Earth's rotation of claim 16, wherein said first gimbal and said second gimbal rotate in one direction and said double central pulley rotates in an opposite another direction.

18. The electric power generating system for extracting mechanical energy from Earth's rotation of claim 17, wherein the rotational motion of said first beam and said second beam rotates said central shaft, and further wherein said central shaft coupled to an electric generator for the generating of electricity.

19. A method of extracting mechanical energy from Earth's rotation to generate electric power, the method comprising the steps of:
providing an electric power generating system having a first support column, a second support column, a first beam member, a second beam member, a first pivot point, a second pivot point, a first gimbal, a second gimbal, a first gyroscope, and a second gyroscope, wherein said first beam member parallel with said second beam member;
mounting said first beam on said first pivot point at a midpoint of said first beam, wherein said first pivot point proximal to a top end of said first support column;
securing said first support column to the ground;
mounting said second beam on said second pivot point at a midpoint of said second beam, wherein said second pivot point proximal to a top end of said second support column;
securing said second support column to the ground;
wherein said first support column is parallel to said second support column;
wherein said first beam rotatable about said first pivot point;
wherein said second beam rotatable about said second pivot point;
mounting said first gimbal between a first end of said first beam and a first end of said second beam;
mounting said second gimbal between a second end of said first beam and a second end of said second beam;
operatively coupling said first gyroscope to said first gimbal;
operatively coupling said second gyroscope to said second gimbal;
wherein said first gyroscope having a first axis of rotation;
wherein said second gyroscope having a second axis of rotation;
wherein said first axis of rotation and said second axis of rotation perpendicular to the Earth's axis of rotation;
wherein said first gimbal tilts said first gyroscope for maintaining a first rotational direction of said first gyroscope;
wherein said second gimbal tilts said second gyroscope for maintaining a second rotational direction of said second gyroscope;
wherein said first gyroscope and said second gyroscope resist changes in orientation; and
applying a torque to said first gyroscope and said second gyroscope through the rotation of the Earth.

20. The method of extracting mechanical energy from Earth's rotation to generate electric power of claim 19, wherein said pulley system having belts passing through said pulley system and connecting a first pulley and a second pulley, and a double central pulley therebetween;
wherein said pulley system having said double central pulley between said first pulley and said second pulley;
wherein said double central pulley operatively coupled to a central shaft disposed across said first pivot point and said second pivot point; and
further wherein said double central pulley rotatably coupled to said first pulley with a first belt and rotatably coupled to said second pulley with a second belt.
